(19) United States
(12) Patent Application Publication
(10) Pub. No.: US 2024/0162474 A1
(43) Pub. Date: May 16, 2024

(54) CYLINDRICAL SECONDARY CELL

(71) Applicant: Northvolt AB, Stockholm (SE)

(72) Inventors: Tetsuya MAKINO, Solna (SE); Koki INOUE, Enköping (SE); Takuma SAKAMOTO, Stockholm (SE)

(21) Appl. No.: 18/263,156

(22) PCT Filed: Feb. 4, 2022
(86) PCT No.: PCT/EP2022/052713

§ 371 Date: Jul. 27, 2023

Related U.S. Application Data
(60) Provisional application No. 63/146,524, filed on Feb. 5, 2021.

(51) Int. Cl. H01M 10/04; H01M 50/107; H01M 50/186; H01M 50/342; H01M 50/533; H01M 50/56; H01M 50/567

(52) U.S. Cl. CPC H01M 10/0431; H01M 10/0422; H01M 50/107; H01M 50/186; H01M 50/3425; H01M 50/533; H01M 50/56; H01M 50/567

(57) ABSTRACT

Two cylindrical secondary cells (1) and methods for assembling them, comprising a cylindrical can (2), a terminal (3), and a first conductive sheet (4), with first electrode coating, wound to form a jelly roll (5). The first conductive sheet (4) comprises a portion (4a) free of first electrode coating. An electrically conductive electrode lead plate (6) is arranged in direct contact with at least part of the portion (4a) free of first electrode coating. The electrode lead plate (6) comprises a protrusion (6a) extending through an opening (2c) in the can (2), and the protrusion (6a) comprises a rivet head (6b) on an outside of the can (2). The rivet head (6b) forms at least part of the terminal (3). Alternatively, the electrode lead plate (6) comprises a hollow protrusion (6a) which protrudes through an opening (2c) in the can (2), and the part of the protrusion (6a) which is exposed to the outside of the can (2) comprises a vent arrangement (11).

### TECHNICAL FIELD

The present disclosure relates to cylindrical secondary cells and methods for assembling them.

### BACKGROUND

The transition from fossil fuels towards renewable energy has gained considerable momentum. One of the most important contributing factors is the development of better and cheaper rechargeable batteries. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed production speed so that producing companies can meet the demand. To achieve an effective production of rechargeable batteries, steps of the manufacturing process can be optimized.

Another aspect to consider is that the rechargeable batteries must be safe to use. Therefore, rechargeable batteries have at least one vent for releasing gas when the pressure inside the batteries rises above an allowed level. The vents are often complicated arrangements.

A rechargeable battery, or, in other words, a secondary battery, comprises one or more secondary cells.

### SUMMARY

In view of the above, it is an aim of the disclosure to provide an improved cylindrical secondary cell for rechargeable batteries.

This aim is achieved by the devices and methods as defined in the appended claims.

The disclosure provides a cylindrical secondary cell comprising:
a cylindrical can comprising a first can end side,
a terminal,
a first conductive sheet, with first electrode coating, wound to form a jelly roll which is arranged in the can, and wherein the first conductive sheet comprises a portion free of first electrode coating which protrudes on a first end side of the jelly roll, and
an electrode lead plate which is electrically conductive and arranged at the first end side of the jelly roll and in direct contact with at least part of the portion free of first electrode coating of the first conductive sheet.

The electrode lead plate comprises a protrusion, which extends through an opening in the can. The opening is arranged in the first can end side. The protrusion comprises a rivet head arranged on an outside of the can, wherein the rivet head forms at least part of the terminal.

With this, the electrode lead plate, which is a current collector for the portion free of first electrode coating, forms one single piece with at least part of the terminal. This means that the number of parts can be reduced in the cylindrical secondary cell which reduces both cost and production time. Also, the current from the portion free of first electrode coating has an uninterrupted path directly to the terminal. This can increase the energy output of the secondary cell.

According to some aspects, the rivet head forms the whole terminal. With this, the number of parts can be reduced even further by letting the rivet head form the whole terminal of the secondary cell.

According to some aspects, wherein the diameter of the rivet head is larger than the diameter of the opening of the can and the area of the rivet head is less than 50% of the total area of the first can end side. The diameter is larger than the opening so that the rivet head cannot go into the opening and is fastened there. Also, the diameter of the rivet head is larger than the opening so that it seals the opening. The area of the rivet head is less than 50% of the total area of the first can end side so that there is a large enough area of the first can end side for an external load, like a bus bar which is used to connect between secondary cells.

According to some aspects, the cylindrical secondary cell comprises an insulation layer arranged between the can and the terminal so that the can is insulated from the terminal. Depending on the design of the can, this may be necessary to make sure that the current from the terminal does not go through the can.

According to some aspects, the cylindrical secondary cell comprises a sealing part arranged between the can and the electrode lead plate so that the insulation layer and the sealing part together insulate the can from the electrode lead plate. Depending on the design of the can, this may be necessary to make sure that the current from the electrode lead plate does not go through the can.

According to some aspects, the cylindrical secondary cell comprises a second conductive sheet with second electrode coating and a separator sheet. The first conductive sheet, the separator sheet and the second conductive sheet are wound to form the jelly roll. A tabless cylindrical secondary cell is thus formed. In contrast, in many solutions a tab is connected to the jelly roll and welded to the underside of the cap.

According to some aspects, the rivet head comprises a vent arrangement. By adding a vent functionality to the rivet head, the number of parts necessary for the secondary cell is further reduced.

According to some aspects, the vent arrangement comprises a thinning of material in the rivet head which is arranged to rupture when an internal pressure in the can exceeds a predetermined level.

According to some aspects, the vent arrangement comprises at least one notch in the rivet head which is arranged to rupture when an internal pressure in the can exceeds a predetermined level.

There are thus several ways to achieve a vent arrangement in the rivet head.

The disclosure provides a method for assembling the cylindrical secondary cell. The jelly roll of the cylindrical secondary cell has the shape of a hollow cylinder such that it has a hole between the first end side of the jelly roll and a second end side of the jelly roll. The protrusion of the electrode lead plate is centrally arranged on the electrode lead plate. The assembling the cylindrical secondary cell comprises:
arranging the electrode lead plate so that the protrusion extends through the opening in the can,
arranging the jelly roll in the can so that at least part of the portion free of first electrode coating of the first conductive sheet is in direct contact with the electrode lead plate,
inserting at least part of a mandrel into the hole of the jelly roll from the second end side of the jelly roll, the mandrel comprising a mandrel end, and
pressing, from a side opposite of the side of where the mandrel has been inserted, a pressing arrangement on the protrusion so that the protrusion is deformed between the mandrel end and the pressing part and thus forms the rivet head.

With this assembly method, the hole through the jelly roll is utilized to use a mandrel from the inside of the secondary cell for the riveting of the protrusion of the electrode lead plate. This is a fast and reliable method to form the rivet head and thus at least part of the terminal. It also does not require any complicated tools.

According to some aspects, the protrusion of the electrode lead plate comprises, before assembling the cylindrical secondary cell, a hollow cylindrical protrusion which is closed at the end which is to extend through the opening in the can. The mandrel has a diameter such that it fits in the hollow cylindrical protrusion. Inserting at least part of a mandrel into the hole of the jelly roll from the second end side of the jelly roll comprises to insert the mandrel until it is inserted a predetermined length into the hollow cylindrical protrusion which leaves a gap between the mandrel end and the closed end of the hollow cylindrical protrusion. This is for when the protrusion of the electrode lead plate is hollow. This is optional but it is the case when there is a vent arrangement on the rivet head.

According to some aspects, the mandrel comprises a ledge arranged at a predetermined distance from the mandrel end such that when the mandrel is inserted into the hole of the jelly roll, the mandrel ledge abuts the electrode lead plate when the mandrel has been inserted the predetermined length into the hollow cylindrical protrusion and thereby prevents the mandrel from being inserted further. By having a ledge at a predetermined distance, the mandrel is prevented from being inserted too far into the hollow cylindrical protrusion of the electrode lead plate. This could also be done in other ways, for example using a control system for moving the mandrel. Both can of course also be used.

The disclosure provides a cylindrical secondary cell comprising:
a cylindrical can comprising a first can end side,
a terminal,
a first conductive sheet, with first electrode coating, wound to form a jelly roll which is arranged in the can, and wherein the first conductive sheet comprises a portion free of first electrode coating which protrudes on a first end side of the jelly roll, and
an electrode lead plate which is electrically conductive and arranged at the first end side of the jelly roll and in direct contact with at least part of the potion free of first electrode coating of the first conductive sheet,

The electrode lead plate comprises a hollow protrusion which protrudes through an opening in the can such that a part of the protrusion is exposed to the outside of the can. The part of the protrusion which is exposed to the outside of the can comprises a vent arrangement.

With this, the electrode lead plate, which is a current collector for the portion free of first electrode coating, forms one single piece with a vent arrangement. This means that the number of parts can be reduced in the cylindrical secondary cell which reduces both cost and production time.

According to some aspects, the part of the protrusion exposed to the outside of the can comprises at least part of the terminal. By adding a terminal functionality to the part of the protrusion exposed to the outside of the can, the number of parts necessary for the secondary cell is further reduced. Also, the current from the portion free of first electrode coating has an uninterrupted path directly to the terminal. This can increase the energy output of the secondary cell.

According to some aspects, the vent arrangement comprises a thinning of material which is arranged to rupture when an internal pressure in the can exceeds a predetermined level.

According to some aspects, the vent arrangement comprises at least one notch which is arranged to rupture when an internal pressure in the can exceeds a predetermined level.

There are thus several ways to achieve a vent arrangement in the part of the protrusion exposed to the outside of the can.

According to some aspects, the cylindrical secondary cell comprises a second conductive sheet with second electrode coating and a separator sheet. The first conductive sheet, the separator sheet and the second conductive sheet are wound to form the jelly roll. A tabless cylindrical secondary cell is thus formed.

The disclosure provides a method for assembling the cylindrical secondary cell. The jelly roll of the cylindrical secondary cell has the shape of a hollow cylinder such that it has a hole between the first end side of the jelly roll and a second end side of the jelly roll. The protrusion of the electrode lead plate is centrally arranged on the electrode lead plate and comprises, before assembling the cylindrical secondary cell, a hollow cylindrical protrusion which is closed at an end side which is to extend through the opening in the can. The end side comprises the vent arrangement. The assembling the cylindrical secondary cell comprises:
arranging the electrode lead plate so that the protrusion extends through the opening in the can,
arranging the jelly roll in the can so that at least part of the portion free of first electrode coating of the first conductive sheet is in direct contact with the electrode lead plate,
inserting at least part of a mandrel into the hole of the jelly roll from the second end side of the jelly roll, the mandrel having a diameter such that it fits in the hollow cylindrical protrusion and comprises a mandrel end, the mandrel is inserted until it is inserted a predetermined length into the hollow cylindrical protrusion which leaves a gap between the mandrel end and the closed end of the hollow cylindrical protrusion, and
pressing, from a side opposite of the side of where the mandrel has been inserted, a pressing arrangement on the closed end of the hollow cylindrical protrusion so that the hollow cylindrical protrusion is deformed between the mandrel end and the pressing part and thus forms a rivet head.

With this assembly method, the hole through the jelly roll is utilized to use a mandrel from the inside of the secondary cell for the riveting of the protrusion of the electrode lead plate. This is a fast and reliable method to form the rivet head with the vent arrangement. It also does not require any complicated tools.

According to some aspects, the mandrel comprises a ledge arranged at a predetermined distance from the mandrel end such that when the mandrel is inserted into the hole of the jelly roll, the mandrel ledge abuts the electrode lead plate when the mandrel has been inserted the predetermined length into the hollow cylindrical protrusion and thereby prevents the mandrel from being inserted further.

By having a ledge at a predetermined distance, the mandrel is prevented from being inserted too far into the hollow cylindrical protrusion of the electrode lead plate. This could also be done in other ways, for example using a control system for moving the mandrel. Both can of course also be used.

### BRIEF SUMMARY OF THE DRAWINGS

Different aspects are now described, by way of example, with reference to the accompanying drawings, in which:

FIG. 1 shows a cut through of an example cylindrical secondary cell where a rivet head forms a part of a terminal.

FIG. 2 shows the example of FIG. 1 without the cut through.

FIG. 3 shows the example of FIG. 1 from the side.

FIG. 4 shows the example of FIG. 1 zoomed in.

FIG. 5 shows a cut through of an example cylindrical secondary cell where a rivet head forms the whole terminal.

FIG. 6 shows the example of FIG. 5 without the cut through.

FIG. 7 shows the example of FIG. 5 from the side.

FIG. 8a-f shows examples of possible different vent arrangements as seen from above.

FIG. 9a-c shows the steps of an example of how a mandrel is used to form the rivet head.

### DETAILED DESCRIPTION

The disclosure is not limited to the embodiments disclosed but may be varied and modified within the scope of the claims.

Aspects of the disclosure will now be described with reference to the accompanying drawings. The devices and methods disclosed herein can, however, be realized in many different forms and should not be construed as being limited to the aspects set forth herein.

The terminology used herein is for the purpose of describing particular aspects of the disclosure only and is not intended to limit the invention. The singular forms “a”, “an” and “the” are intended to include plural forms as well, unless the context clearly indicates otherwise.

With the term “terminal” is meant a part of a secondary cell which is to be connected to an external load.

Alternative terms for the term “can” are “case” and “housing case”.

Alternative terms for the term “conductive sheet” are “conductive substrate” and “current collector”.

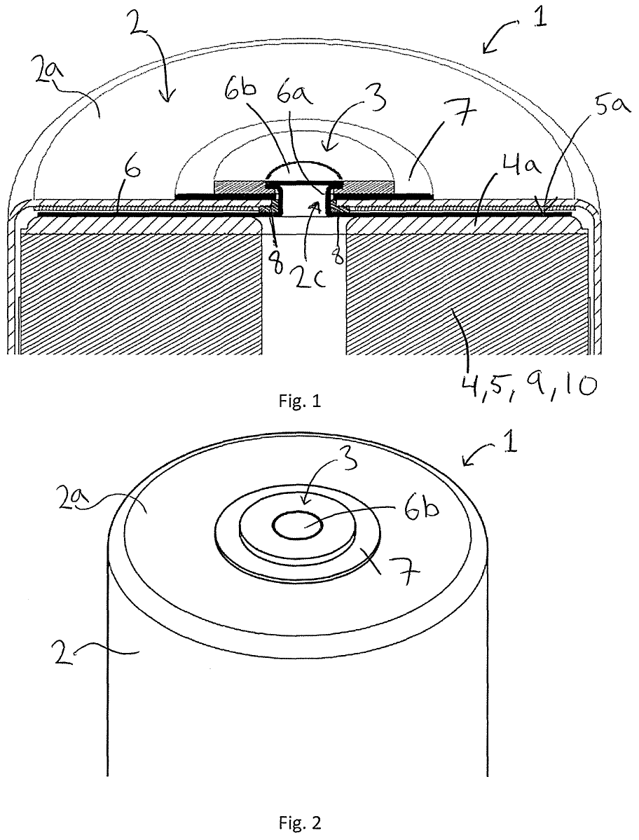

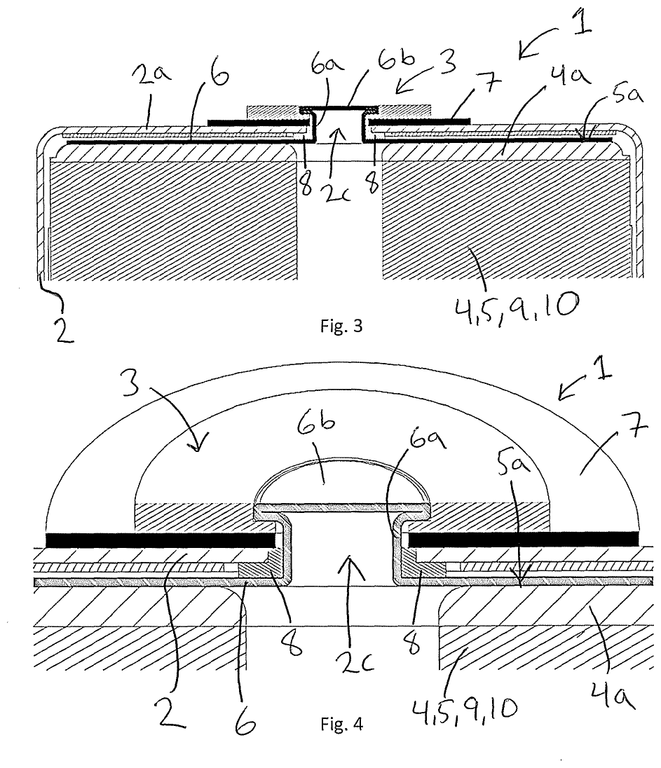

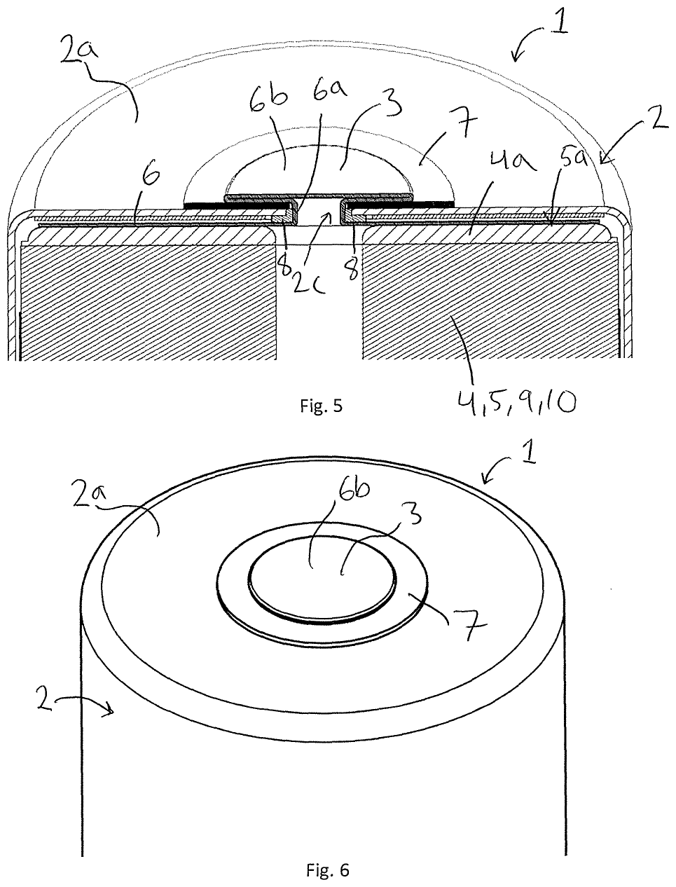

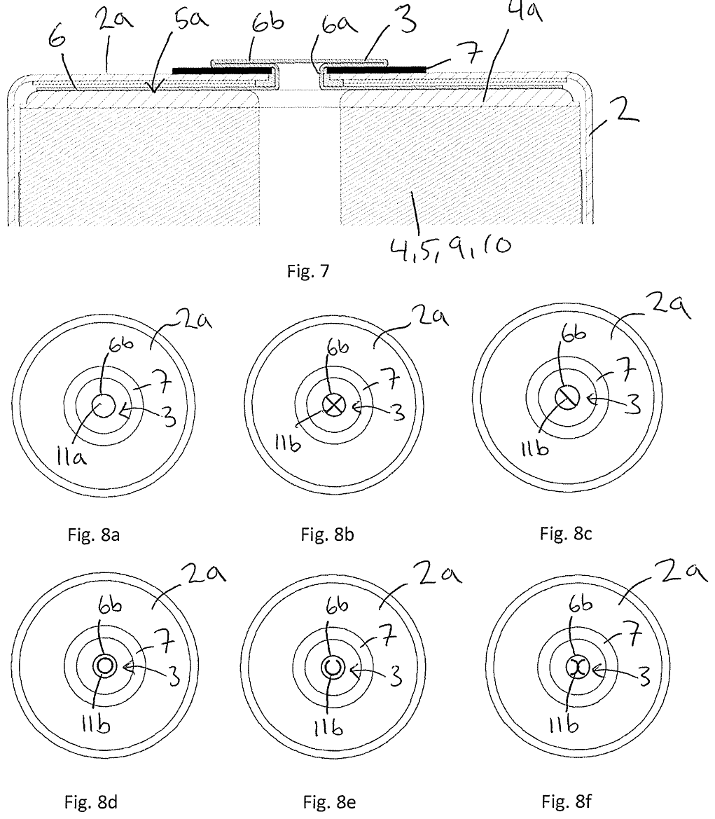

FIGS. 1-4 show examples of cylindrical secondary cells 1 where a rivet head 6b forms a part of a terminal 3. FIGS. 5-7 show examples of cylindrical secondary cells 1 where a rivet head 6b forms the whole terminal 3.

The disclosure provides a cylindrical secondary cell 1 comprising a cylindrical can 2 comprising a first can end side 2a. The cylindrical can 2 thus forms a housing of the cylindrical secondary cell 1. The cylindrical secondary cell 1 comprises a terminal 3 and a first conductive sheet 4, with first electrode coating, wound to form a jelly roll 5 which is arranged in the can 2. The first conductive sheet 4 comprises a portion 4a free of first electrode coating which protrudes on a first end side 5a of the jelly roll 5. In other words, the first conductive sheet 4 has a part which is free of the first electrode coating and when it is wound to a jelly roll 5, the part which is free of the first electrode coating is arranged at the first end side 5a of the jelly roll 5. By this, the first conductive sheet 4 is exposed at the first end side of the jelly roll 5.

According to some aspects, the cylindrical secondary cell 1 may comprise a second conductive sheet 9 with second electrode coating and a separator sheet 10. The first conductive sheet 4, the separator sheet 10 and the second conductive sheet are then wound to form the jelly roll 5. In this example, the cylindrical secondary cell 1 forms a tabless cell. Alternatively, there are two separator sheets 10 so that the first conductive sheet 4, a first separator sheet 10, the second conductive sheet 9 and a second separator sheet 10 are wound to form the jelly roll 5. It may also be the case that there is no separator sheet, for example if a solid electrolyte is used in the cylindrical secondary cell 1.

The cylindrical secondary cell 1 comprises an electrode lead plate 6 which is electrically conductive and arranged at the first end side 5a of the jelly roll 5 and in direct contact with at least part of the portion 4a free of first electrode coating of the first conductive sheet 4. The electrode lead plate 6 is to collect current from the portion 4a free of first electrode coating of the first conductive sheet 4. The electrode lead plate 6 comprises, for example, any of, and any combination of: Aluminum, Stainless steel, Aluminum alloy, composed with at least one of Copper (Cu), Manganese (Mn), Silicon (Si), Magnesium (Mg), and Zinc (Zn). The electrode lead plate is for example between 0.1 mm and 2.0 mm thick and preferably between 0.3 mm and 1 mm thick.

The electrode lead plate 6 comprises a protrusion 6a, which extends through an opening 2c in the can 2. The opening 2c is arranged in the first can end side 2a. The area of the opening 2c is, for example, between 0.4% and 10% of the area of the first can end side 2a. The area of the opening 2c is, for example, between 0.5% and 5% of the area of the first can end side 2a. The protrusion 6a comprises a rivet head 6b arranged on an outside of the can 2, wherein the rivet head 6b forms at least part of the terminal 3. With this, the electrode lead plate 6, which is a current collector for the portion 4a free of first electrode coating, forms one single piece with at least part of the terminal 3. This means that the number of parts can be reduced in the cylindrical secondary cell 1 which reduces both cost and production time. Also, the current from the portion 4a free of first electrode coating has an uninterrupted path directly to the terminal 3. This can increase the energy output of the secondary cell 1. The protrusion 6a of the electrode lead plate 6 may have a different thickness than the rest of the electrode lead plate 6.

In the case when the rivet head 6b forms at least part of the terminal 3, the part of the terminal not comprising the rivet head has a cut out so that the top part of the rivet head 6b is level with the top surface of the terminal 3. This can be seen in FIGS. 1, 3, 4 and 9a-c.

Alternatively, the electrode lead plate 6 comprises a hollow protrusion 6a which protrudes through an opening 2c in the can 2 such that a part of the protrusion 6a is exposed to the outside of the can 2. The part of the protrusion 6a which is exposed to the outside of the can 2 comprises a vent arrangement 11. With this, the electrode lead plate 6, which is a current collector for the portion 4a free of first electrode coating, forms one single piece with a vent arrangement 11. This means that the number of parts can be reduced in the cylindrical secondary cell 1 which reduces both cost and production time.

The cylindrical secondary cell 1 of the disclosure is compatible with cylindrical secondary cells comprising a cylindrical can 2 comprising a first can end side 2a, a terminal 3, a first conductive sheet 4, with first electrode coating, wound to form a jelly roll 5 which is arranged in the can 2, and wherein the first conductive sheet 4 comprises a portion 4a free of first electrode coating which protrudes on a first end side 5a of the jelly roll 5, and an electrode lead plate 6 which is electrically conductive and arranged at the first end side 5a of the jelly roll 5 and in direct contact with at least part of the portion 4a free of first electrode coating of the first conductive sheet 4. As for other parts of the cylindrical secondary cell 1, for example in relation to the second can end side 2b, there are many ways to design them which are known to a skilled person and will not be presented here. It should be noted that the second can end side 2b cannot be seen in the figures.

The electrode lead plate 6 may, of course, both form at least part of the terminal 3 and comprise a vent arrangement 11. Thus, in the case where the rivet head 6b forms at least part of the terminal 3, the rivet head 6b may also comprises a vent arrangement 11. By adding a vent functionality to the rivet head 6b, the number of parts necessary for the secondary cell 1 is further reduced. In this case, the protrusion 6a comprising a rivet head 6b is hollow to allow for gas to access the vent in the rivet head 6b.

In the case where the part of the protrusion 6a which is exposed to the outside of the can 2 comprises a vent arrangement 11, the part of the protrusion 6a exposed to the outside of the can 2 may comprise at least part of the terminal 3. By adding a terminal 3 functionality to the part of the protrusion 6a, the number of parts necessary for the secondary cell 1 is further reduced. Also, the current from the portion 4a free of first electrode coating has an uninterrupted path directly to the terminal 3. This can increase the energy output of the secondary cell 1.

For all the example aspects, the vent arrangement 11, or pressure relief structure, can be realised in several ways. Preferably, the vent arrangement 11 may be formed as a non-reclosing pressure relief structure having a weakened portion or rupture indication designed to fail at a predetermined differential pressure. According to some aspects, the vent arrangement 11 comprises a thinning 11a of material which is arranged to rupture when an internal pressure in the can 2 exceeds a predetermined level. According to some aspects, the vent arrangement 11 comprises at least one notch 11b which is arranged to rupture when an internal pressure in the can 2 exceeds a predetermined level. There are thus several ways to achieve a vent arrangement 11 in the part of the protrusion 6a exposed to the outside of the can 2 and the rivet head 6b. FIG. 8a shows an example cylindrical secondary cell 1 from above where the rivet head 6b comprises a vent arrangement 11 in the form of a thinning 11a of material. FIGS. 8b-f shows examples from above where the rivet head 6b comprises a vent arrangement 11 in the form of a notch 11b. The figures show different examples of patterns for the notch 11b. The notch depth is decided depending on what rupture pressure is desired. The desired rupture pressure depends on what materials have been used in the secondary cell.

As can be seen in FIGS. 8b-f, FIG. 8b shows a notch with a cross shape, FIG. 8c shows a notch with a line shape, FIG. 8d shows a notch with a circular shape, FIG. 8e shows a notch with a horseshoe shape and FIG. 8d shows a notch with the shape of two semicircles.

According to some aspects, the rivet head 6b forms the whole terminal 3. With this, the number of parts can be reduced even further by letting the rivet head 6b form the whole terminal 3 of the secondary cell 1. Again, FIGS. 5-7 shows different views of example cylindrical secondary cells 1 where a rivet head 6b forms the whole terminal 3.

In both the case when the rivet head 6b forms a part of the terminal 3 and when the rivet head 6b forms the whole terminal 3, the diameter of the rivet head is larger than the diameter of the opening of the can and the area of the rivet head is less than 50% of the total area of the first can end side. The diameter is larger than the opening so that the rivet head cannot go into the opening. In other words, the rivet head 6b is larger than the opening 2c in the can 2. Also, the total area of the top side surface of the rivet head 6b is less than 50% of the total area of the first can end side 2a.

According to some aspects, the cylindrical secondary cell 1 comprises an insulation layer 7 arranged between the can 2 and the terminal 3 so that the can 2 is insulated from the terminal 3. Depending on the design of the can 2, this may be necessary to make sure that the current from the terminal 3 does not go through the can 2.

The insulation layer 7 comprises, for example, any of, and any combination of: Glass fibre reinforced Polycarbonate (PC+GF), Polycarbonate (PC), Polypropylene (PP), Polyethylene (PE), Polyphenylene Sulfide (PPS), Polyphenylene ether (PPE), Polyethylene terephthalate (PET).

According to some aspects, the cylindrical secondary cell 1 comprises a sealing part 8 arranged between the can 2 and the electrode lead plate so that the insulation layer 7 and the sealing part 8 together insulate the can 2 from the electrode lead plate. Depending on the design of the can 2, this may be necessary to make sure that the current from the electrode lead plate does not go through the can 2.

The sealing part 8 is for example a gasket made from resin, such as Polypropylene (PP), Polybutylene terephthalate (PBT), Perfluoroalkoxy alkane (PFA), Polytetrafluoroethylene (PTFE), Polyphenylene Sulfide (PPS), Polyether ether ketone (PEEK) or the like or a combination thereof, or an O-ring made from rubber, such as Styrene-butadiene rubber (SBR), Ethylene propylene diene monomer rubber (EPDM), Silicone Elastomer, Fluorocarbon rubber (FKM) or the like or a combination thereof.

It should be noted that depending on the design of the sealing part 8, there might be a need for an inner insulator between the electrode lead plate 6 and the can 2. An example of such an inner insulator can be seen in FIGS. 1, 3, 4, 5, 7 and 9a-c in the form of a plate with an opening for the sealing part 8 and the protrusion 6a. The material for such an inner insulator is, for example, any of, or a combination of any of: Polypropylene (PP), Polyethylene (PE), Polyphenylene Sulfide (PPS), Polyphenyleneether (PPE), Polycarbonate (PC), Polyethylene terephthalate (PET).

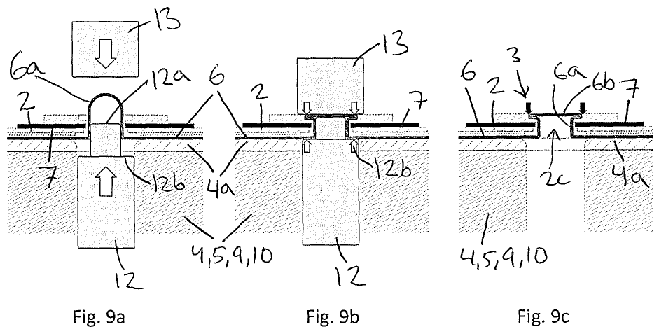

FIG. 9a-c shows the steps of an example of how a mandrel 12 is used to form the rivet head 6b. In the illustrated example, the protrusion 6a is hollow but it is also possible to use the same method with a solid protrusion. For the below described methods, the jelly roll 5 of the cylindrical secondary cell 1 has the shape of a hollow cylinder such that it has a hole between the first end side 5a of the jelly roll 5 and a second end side of the jelly roll 5. Also, the protrusion 6a of the electrode lead plate is centrally arranged on the electrode lead plate.

In the case where there is no vent in the rivet head 6b, the disclosure provides a method for assembling the cylindrical secondary cell 1 comprises:
arranging the electrode lead plate so that the protrusion 6a extends through the opening 2c in the can 2,
arranging the jelly roll 5 in the can 2 so that at least part of the portion 4a free of first electrode coating of the first conductive sheet 4 is in direct contact with the electrode lead plate,
inserting at least part of a mandrel 12 into the hole of the jelly roll 5 from the second end side of the jelly roll 5, the mandrel 12 comprising a mandrel end 12a,
pressing, from a side opposite of the side of where the mandrel 12 has been inserted, a pressing arrangement 13 on the protrusion 6a so that the protrusion 6a is deformed between the mandrel end 12a and the pressing part and thus forms the rivet head 6b.

In FIG. 9a, it is illustrated when the mandrel 12 is arranged in the jelly roll 5 and the pressing arrangement 13 is over the cylindrical cell 1. In FIG. 9b, the mandrel 12 and the pressing arrangement 13 have been pressed together to form the rivet head 6b. In FIG. 9c, it can be seen that the rivet head 6b is now filling a cut out of the terminal so that the top part of the rivet head 6b is level with the top surface of the terminal.

It should be noted that the first can end side 2a may be closed, besides for the opening 2c, so that the electrode lead plate is arranged so that the protrusion 6a extends through the opening 2c in the can 2 by inserting the electrode lead plate from the opposite end of the can 2, i.e., the second can end side 2b. If the first can end side 2a is not attached to the rest of the can 2 before assembly, the electrode lead plate may be arranged so that the protrusion 6a extends through the opening 2c in the can 2 before arranging the first can end side 2a to the rest of the can 2. The same goes for the jelly roll 5, if the first can end is closed besides the hole, the jelly roll 5 is inserted from the second can end side 2b. If it is not attached to the rest of the can 2 before assembly, the jelly roll 5 can also be put in the can 2 before arranging the first can end side 2a to the rest of the can 2. In such a case, the jelly roll 5 may be arranged in the can 2 before the electrode lead plate is arranged in the can 2. Also, in such a case, the electrode lead plate may be arranged on the portion 4a free of first electrode coating of the first conductive sheet 4 before arranging the first can end side 2a on the rest of the can 2.

With this assembly method, the hole through the jelly roll 5 is utilized to use a mandrel 12 from the inside of the secondary cell 1 for the riveting of the protrusion 6a of the electrode lead plate. This is a fast and reliable method to form the rivet head 6b and thus at least part of the terminal 3. It also does not require any complicated tools.

In the case when the protrusion 6a is hollow, the protrusion 6a of the electrode lead plate comprises, before assembling the cylindrical secondary cell 1, a hollow cylindrical protrusion 6a which is closed at the end which is to extend through the opening 2c in the can 2. The mandrel 12 then has a diameter such that it fits in the hollow cylindrical protrusion 6a. Inserting at least part of a mandrel 12 into the hole of the jelly roll 5 from the second end side of the jelly roll 5 comprises to insert the mandrel 12 until it is inserted a predetermined length into the hollow cylindrical protrusion 6a which leaves a gap between the mandrel end 12a and the closed end of the hollow cylindrical protrusion 6a. This is for when the protrusion 6a of the electrode lead plate is hollow. This is optional but it is the case when there is a vent arrangement 11 on the rivet head 6b.

According to some aspects, the mandrel 12 comprises a ledge 12b arranged at a predetermined distance from the mandrel end 12a such that when the mandrel 12 is inserted into the hole of the jelly roll 5, the mandrel ledge 12b abuts the electrode lead plate when the mandrel 12 has been inserted the predetermined length into the hollow cylindrical protrusion 6a and thereby prevents the mandrel 12 from being inserted further. By having a ledge at a predetermined distance, the mandrel 12 is prevented from being inserted too far into the hollow cylindrical protrusion 6a of the electrode lead plate. This could also be done in other ways, for example using a control system for moving the mandrel 12. Both can of course also be used.

The ledge also has a function of pressurising the sealing part 8 discussed above. Pressurising the sealing part 8 improves the sealing function of the sealing part 8.

In the case where the end side of the protrusion 6a comprises a vent arrangement 11, the method of assembly is the same as above when the protrusion 6a is hollow: The jelly roll 5 of the cylindrical secondary cell 1 has the shape of a hollow cylinder such that it has a hole between the first end side 5a of the jelly roll 5 and a second end side of the jelly roll 5. The protrusion 6a of the electrode lead plate is centrally arranged on the electrode lead plate and comprises, before assembling the cylindrical secondary cell 1, a hollow cylindrical protrusion 6a which is closed at an end side which is to extend through the opening 2c in the can 2. The end side comprises the vent arrangement 11. The assembling the cylindrical secondary cell 1 comprises:
arranging the electrode lead plate so that the protrusion 6a extends through the opening 2c in the can 2,
arranging the jelly roll 5 in the can 2 so that at least part of the portion 4a free of first electrode coating of the first conductive sheet 4 is in direct contact with the electrode lead plate,
inserting at least part of a mandrel 12 into the hole of the jelly roll 5 from the second end side of the jelly roll 5, the mandrel 12 having a diameter such that it fits in the hollow cylindrical protrusion 6a and comprises a mandrel end 12a, the mandrel 12 is inserted until it is inserted a predetermined length into the hollow cylindrical protrusion 6a which leaves a gap between the mandrel end 12a and the closed end of the hollow cylindrical protrusion 6a,
pressing, from a side opposite of the side of where the mandrel 12 has been inserted, a pressing arrangement 13 on the closed end of the hollow cylindrical protrusion 6a so that the hollow cylindrical protrusion 6a is deformed between the mandrel end 12a and the pressing part and thus forms a rivet head 6b.

With this assembly method, the hole through the jelly roll 5 is utilized to use a mandrel 12 from the inside of the secondary cell 1 for the riveting of the protrusion 6a of the electrode lead plate. This is a fast and reliable method to form the rivet head 6b with the vent arrangement 11. It also does not require any complicated tools.

According to some aspects, the mandrel 12 comprises a ledge 12b arranged at a predetermined distance from the mandrel end 12a such that when the mandrel 12 is inserted into the hole of the jelly roll 5, the mandrel ledge 12b abuts the electrode lead plate when the mandrel 12 has been inserted the predetermined length into the hollow cylindrical protrusion 6a and thereby prevents the mandrel 12 from being inserted further.

By having a ledge at a predetermined distance, the mandrel 12 is prevented from being inserted too far into the hollow cylindrical protrusion 6a of the electrode lead plate. This could also be done in other ways, for example using a control system for moving the mandrel 12. Both can of course also be used.

### REFERENCE LIST

1. Cylindrical secondary cell
2. Cylindrical can
   a. First can end side
   b. Second can end side (not seen in the figures)
   c. Opening
3. Terminal
4. First conductive sheet
   a. Portion free of first electrode coating
5. Jelly roll
   a. First end side
6. Electrode lead plate
   a. Protrusion
   b. Rivet head
7. Insulation layer
8. Sealing part
9. Second conductive sheet
10. Separator sheet
11. Vent arrangement
   a. Thinning
   b. Notch
12. Mandrel
   a. End
   b. Ledge
13. Pressing arrangement

1-19. (canceled)

20. A cylindrical secondary cell comprising:
a cylindrical can comprising a first can end side
a terminal,
a first conductive sheet, with first electrode coating, wound to form a jelly roll which is arranged in the can, and wherein the first conductive sheet comprises a portion (4a) free of first electrode coating which protrudes on a first end side of the jelly roll, and
an electrode lead plate which is electrically conductive and arranged at the first end side of the jelly roll and in direct contact with at least part of the portion free of first electrode coating of the first conductive sheet,
wherein the electrode lead plate comprises a protrusion, which extends through an opening in the can, the opening being arranged in the first can end side, and the protrusion comprises a rivet head arranged on an outside of the can, wherein the rivet head forms at least part of the terminal.

21. The cylindrical secondary cell according to claim 20, wherein the rivet head forms the whole terminal.

22. The cylindrical secondary cell according to claim 20, wherein the diameter of the rivet head is larger than the diameter of the opening of the can and the area of the rivet head is less than 50% of the total area of the first can end side.

23. The cylindrical secondary cell according to claim 20, comprising an insulation layer arranged between the can and the terminal so that the can is insulated from the terminal.

24. The cylindrical secondary cell according to claim 23, comprising a sealing part arranged between the can and the electrode lead plate so that the insulation layer and the sealing part together insulate the can from the electrode lead plate.

25. The cylindrical secondary cell according to claim 20, comprising:
a second conductive sheet with second electrode coating, and
a separator sheet,
wherein the first conductive sheet, the separator sheet and the second conductive sheet are wound to form the jelly roll.

26. The cylindrical secondary cell according to claim 20, wherein the rivet head comprises a vent arrangement.

27. The cylindrical secondary cell according to claim 26, wherein the vent arrangement comprises a thinning of material in the rivet head which is arranged to rupture when an internal pressure in the can exceeds a predetermined level.

28. The cylindrical secondary cell according to claim 26, wherein the vent arrangement comprises at least one notch in the rivet head which is arranged to rupture when an internal pressure in the can exceeds a predetermined level.

29. A method for assembling the cylindrical secondary cell according to claim 20, wherein the jelly roll of the cylindrical secondary cell has the shape of a hollow cylinder such that it has a hole between the first end side of the jelly roll and a second end side of the jelly roll, and the protrusion of the electrode lead plate is centrally arranged on the electrode lead plate, wherein the assembling the cylindrical secondary cell comprises:
arranging the electrode lead plate so that the protrusion extends through the opening in the can,
arranging the jelly roll in the can so that at least part of the portion free of first electrode coating of the first conductive sheet is in direct contact with the electrode lead plate,
inserting at least part of a mandrel into the hole of the jelly roll from the second end side of the jelly roll, the mandrel comprising a mandrel end, and
pressing, from a side opposite of the side of where the mandrel has been inserted, a pressing arrangement on the protrusion so that the protrusion is deformed between the mandrel end and the pressing part and thus forms the rivet head.

30. The method according to claim 29, wherein the protrusion of the electrode lead plate comprises, before assembling the cylindrical secondary cell, a hollow cylindrical protrusion which is closed at the end which is to extend through the opening in the can and the mandrel has a diameter such that it fits in the hollow cylindrical protrusion, and wherein inserting at least part of a mandrel into the hole of the jelly roll from the second end side of the jelly roll comprises to insert the mandrel until it is inserted a predetermined length into the hollow cylindrical protrusion which leaves a gap between the mandrel end and the closed end of the hollow cylindrical protrusion.

31. The method according to claim 29, wherein the mandrel comprises a ledge arranged at a predetermined distance from the mandrel end such that when the mandrel is inserted into the hole of the jelly roll, the mandrel ledge abuts the electrode lead plate when the mandrel has been inserted the predetermined length into the hollow cylindrical protrusion and thereby prevents the mandrel from being inserted further.

32. A cylindrical secondary cell comprising:
a cylindrical can comprising a first can end side,
a terminal,
a first conductive sheet, with first electrode coating, wound to form a jelly roll which is arranged in the can, and wherein the first conductive sheet comprises a portion free of first electrode coating which protrudes on a first end side of the jelly roll, and
an electrode lead plate which is electrically conductive and arranged at the first end side of the jelly roll and in direct contact with at least part of the potion free of first electrode coating of the first conductive sheet,
wherein the electrode lead plate comprises a hollow protrusion which protrudes through an opening in the can such that a part of the protrusion is exposed to the outside of the can, and wherein the part of the protrusion which is exposed to the outside of the can comprises a vent arrangement.

33. The cylindrical secondary cell according to claim 32, wherein the part of the protrusion exposed to the outside of the can comprises at least part of the terminal.

34. The cylindrical secondary cell according to claim 32, wherein the vent arrangement comprises a thinning of material which is arranged to rupture when an internal pressure in the can exceeds a predetermined level.

35. The cylindrical secondary cell according to claim 32, wherein the vent arrangement comprises at least one notch which is arranged to rupture when an internal pressure in the can exceeds a predetermined level.

36. The cylindrical secondary cell according to claim 32, comprising:
a second conductive sheet with second electrode coating, and
a separator sheet,
wherein the first conductive sheet, the separator sheet and the second conductive sheet are wound to form the jelly roll.

37. A method for assembling the cylindrical secondary cell according to claim 32, wherein the jelly roll of the cylindrical secondary cell has the shape of a hollow cylinder such that it has a hole between the first end side of the jelly roll and a second end side of the jelly roll, and the protrusion of the electrode lead plate is centrally arranged on the electrode lead plate and comprises, before assembling the cylindrical secondary cell, a hollow cylindrical protrusion which is closed at an end side which is to extend through the opening in the can, wherein the end side comprises the vent arrangement, wherein the assembling the cylindrical secondary cell comprises:
arranging the electrode lead plate so that the protrusion extends through the opening in the can,
arranging the jelly roll in the can so that at least part of the portion free of first electrode coating of the first conductive sheet is in direct contact with the electrode lead plate,
inserting at least part of a mandrel into the hole of the jelly roll from the second end side of the jelly roll, the mandrel having a diameter such that it fits in the hollow cylindrical protrusion and comprises a mandrel end, the mandrel is inserted until it is inserted a predetermined length into the hollow cylindrical protrusion which leaves a gap between the mandrel end and the closed end of the hollow cylindrical protrusion, and
pressing, from a side opposite of the side of where the mandrel has been inserted, a pressing arrangement on the closed end of the hollow cylindrical protrusion so that the hollow cylindrical protrusion is deformed between the mandrel end and the pressing part and thus forms a rivet head.

38. The method according to claim 37, wherein the mandrel comprises a ledge arranged at a predetermined distance from the mandrel end such that when the mandrel is inserted into the hole of the jelly roll, the mandrel ledge abuts the electrode lead plate when the mandrel has been inserted the predetermined length into the hollow cylindrical protrusion and thereby prevents the mandrel from being inserted further.
